(19) United States
(12) Patent Application Publication
(10) Pub. No.: US 2014/0037057 A1
(43) Pub. Date: Feb. 6, 2014

(54) X-RAY IMAGING APPARATUS, AND METHOD OF SETTING IMAGING AREA OF X-RAY IMAGING APPARATUS

(71) Applicant: SAMSUNG ELECTRONICS CO., LTD, Suwon-si (KR)

(72) Inventor: Han Myoung KIM, Suwon-si (KR)

(73) Assignee: SAMSUNG ELECTRONICS CO., LTD, Suwon-si (KR)

(21) Appl. No.: 13/950,457

(22) Filed: Jul. 25, 2013

(30) Foreign Application Priority Data
Jul. 31, 2012 (KR) 10-2012-0084219

(51) Int. Cl. G21K 1/02; G01N 23/04

(52) U.S. Cl. CPC G21K 1/02; G01N 23/04
USPC 378/62; 378/98.2

(57) ABSTRACT

An X-ray imaging apparatus controls an imaging area using an image area setting which includes displaying, on a screen, an X-ray image with respect to an X-ray irradiation area acquired via X-ray irradiation of an X-ray irradiator, receiving a selected-area generation instruction to select a partial area of the X-ray image displayed on the screen from a user, and displaying a selected-area using a boundary line if the selected-area is designated on the screen by the user. Thereafter, the imaging area setting method includes setting the X-ray irradiation area based on the selected-area, and adjusting the X-ray irradiator so as to irradiate the X-ray irradiation area with X-rays.

### CROSS-REFERENCE TO RELATED APPLICATIONS

This application claims the priority benefit of Korean Patent Applications No. 10-2012-0084219, filed on Jul. 31, 2012 in the Korean Intellectual Property Office, the disclosure of which is incorporated herein by reference.

### BACKGROUND

1. Field

Embodiments disclosed herein relate to an imaging area setting method of an X-ray imaging apparatus, and an X-ray imaging apparatus to enable control of an imaging area using the setting method.

2. Description of the Related Art

An X-ray imaging apparatus may refer to an image system that acquires an image of internal tissues or structures of an object, such as the entire or portions of a human body or various things or objects, by irradiating the object with X-rays (also referred to as Roentgen rays). Examples of the X-ray imaging apparatus includes a general X-ray imaging apparatus, a special area dedicated imaging apparatus, and a Computed Tomography (CT) or Full Field Digital Mammography (FFDM) apparatus.

The X-ray imaging apparatus may be used in a medical image system to detect any diseases or other abnormalities of a human body, may be used to observe internal structures of a thing, and may be used as a scanner to scan luggage in the airport, etc.

The principle of the X-ray imaging apparatus is as follows.

If an object is irradiated with X-rays, the X-rays may be absorbed by or pass through the object or internal tissues of the object, according to properties of the object or the internal tissues or materials of the object. The X-ray imaging apparatus using the above characteristics of X-rays may recognize the internal materials or structures of the object by irradiating the object with X-rays and detecting X-rays having passed through the object or the internal tissues or materials of the object.

More specifically, in the X-ray imaging apparatus, X-rays are generated from a cathode-ray tube installed to an X-ray generator to irradiate an object. As the X-rays pass through the object, some of the X-rays are absorbed by internal materials of the object, and some of the X-rays having passed through the object are received by an X-ray detector.

The X-ray detector receives and detects the X-rays having passed through the object. Then, after changing the detected X-rays into an electric signal, the X-ray detector may generate an X-ray image based on the changed electric signal, thereby providing a user with information on the internal tissues or structures of the irradiated object.

Considering generation of an X-ray image via detection of X-rays by the X-ray detector in more detail, a scintillator provided at a detection panel of the X-ray detector outputs visible photons upon receiving X-rays, and a photodiode changes the output photons into an electric signal. A storage device, such as a capacitor, stores the resulting electric signal, and an image processor of the X-ray imaging apparatus reads out the electric signal stored in the storage device to generate an X-ray image.

The X-ray image generated as described above is subjected to predetermined image processing, and then is transmitted to a display unit that may be separably installed from the X-ray imaging apparatus or may be connected to the X-ray imaging apparatus via a wireless or wired communication network, such as a cable, to display the X-ray image to a user.

### SUMMARY

It is an aspect of the present invention to provide an imaging area setting method of an X-ray imaging apparatus and the related X-ray imaging apparatus, which may assist a user, for example, a radiologist, in easily and accurately setting an X-ray imaging area.

It is another aspect of the present invention to provide an imaging area setting method of an X-ray imaging apparatus and the related X-ray imaging apparatus, which may assist a user in easily setting a required X-ray imaging area when capturing an image of an object using the X-ray imaging apparatus.

It is another aspect of the present invention to provide an imaging area setting method of an X-ray imaging apparatus and the related X-ray imaging apparatus, which may allow X-ray irradiation to be focused on a particular region of an object, for example, a human body, in order to reduce unnecessary exposure of the object to radiation and thereby reduce or minimize the effect of radiation exposure on the object.

It is another aspect of the present invention to allow a user to intuitively set an X-ray imaging area based on an image, rather than based on text.

It is a further aspect of the present invention to achieve enhanced efficiency and accuracy in image diagnosis using an imaging area setting method and an X-ray imaging apparatus or a Full Field Digital Mammography (FFDM) apparatus.

Additional aspects of the invention will be set forth in part in the description which follows and, in part, will be apparent from the description, or may be learned by practice of the invention.

In accordance with one aspect of the invention, an imaging area setting method of an X-ray imaging apparatus, includes displaying, on a screen, an X-ray image with respect to an X-ray irradiation area acquired via X-ray irradiation of an X-ray irradiator, receiving a selected-area generation instruction to select a partial area of the X-ray image displayed on the screen from a user, and setting the X-ray irradiation area based on the selected-area, and adjusting the X-ray irradiator so as to irradiate the X-ray irradiation area with X-rays.

Adjustment of the X-ray irradiator may include controlling a collimator of the X-ray irradiator to adjust the X-ray irradiator.

The X-ray irradiation area may coincide with the selected-area, or may be an area containing the entire selected-area therein.

The selected-area generation instruction may include a selection instruction to designate at least one selection point on the X-ray image.

The selected-area may be generated based on a center position of the X-ray image, and a distance between the center position of the X-ray image and the selected at least one selection point.

The selected-area generation instruction may include a selection instruction to designate plural selection points on the X-ray image, and the selected-area may be generated based on the selected plural selection points.

The selected-area generation instruction may be input by the user via an electric signal generated as the user moves a position marker displayed on the screen, or an electric signal generated as the user touches a touchscreen of a display unit coupled or connected to the X-ray imaging apparatus.

The selected-area may be displayed on the screen using a boundary line when the selected-area is designated on the screen by the user.

In accordance with another aspect of the present invention, an imaging area setting method of an X-ray imaging apparatus, includes displaying, on a screen, a position marker that is moved on the screen according to a user action and an X-ray image acquired via X-ray irradiation of an X-ray irradiator to an X-ray irradiation area, receiving a selection instruction to designate at least one selection point on the X-ray image based on a position of the position marker from a user, setting a selected-area based on the at least one selection point, and displaying the set selected-area using a boundary line, and setting the X-ray irradiation area based on the selected-area, and adjusting the X-ray irradiator so as to irradiate the X-ray irradiation area with X-rays.

Adjustment of the X-ray irradiator may be performed by controlling a collimator of the X-ray irradiator.

The X-ray irradiation area may coincide with the selected-area, or may be an area containing the entire selected-area therein.

The at least one selection point may include at least one point of the X-ray image where the position marker is located, and the selected-area may be set based on a center position of the X-ray image, and a distance between the center position of the X-ray image and the selected at least one selection point.

The selection instruction may include a selection instruction to designate plural selection points on the X-ray image via movement of the position marker performed by the user, and generation of the selected-area on the screen may include generating the selected-area based on the selected plural selection points.

The selected-area may be defined by the center position of the X-ray image and the size of the selected-area, for example, a distance between the center position and the selected-area.

The screen on which the position marker, X-ray image, and the selected-area may be a touchscreen.

In accordance with another aspect of the present invention, an imaging area setting method of an X-ray imaging apparatus, includes displaying, on a touchscreen of a display unit, an X-ray image acquired via X-ray irradiation of an X-ray irradiator to an X-ray irradiation area, receiving a selection instruction to designate at least one selection point on the X-ray image by a user touch action on the touchscreen, setting a selected-area based on the at least one selection point, and displaying the set selected-area using a boundary line, and setting the X-ray irradiation area based on the selected-area, and adjusting the X-ray irradiator so as to irradiate the X-ray irradiation area with X-rays.

Adjustment of the X-ray irradiator may include controlling a collimator of the X-ray irradiator to adjust the X-ray irradiator.

The X-ray irradiation may coincide with the selected-area, or may be an area containing the entire selected-area therein.

The user touch action may include a touch action on at least one point of the X-ray image, or a drag action from a first position on the X-ray image to a second position, different from the first point, on the X-ray image.

The selection instruction may include a selection instruction to designate plural selection points on the X-ray image via a drag action from a first position on the X-ray image to a second position, different from the first point, on the X-ray image, and generation of the selected-area on the screen may include generating the selected-area based on the selected plural selection points.

The selected-area may be defined by the center position of the X-ray image and the size of the selected-area.

In accordance with another aspect of the present invention, an imaging area setting method of an X-ray imaging apparatus, includes displaying, on a screen, an X-ray image acquired via X-ray irradiation of an X-ray irradiator, including a collimator, to an object, displaying, on the screen, an X-ray irradiation area setter that divides a partial area of the X-ray image from the other area if a user inputs a display instruction of the X-ray irradiation area setter, and if the area of the X-ray image divided by the X-ray irradiation area setter is changed as the user operates the X-ray irradiation area setter, adjusting the X-ray irradiator so as to irradiate a changed area with X-rays, wherein the X-ray irradiation area setter includes at least one of plural boundary lines that divide the partial area from the other area, or a layer that overlaps the partial area to divide the partial area from the other area, and wherein the X-ray irradiation area setter includes an adjustment point to adjust the size of the X-ray irradiation area setter or to move the X-ray irradiation area setter.

The X-ray irradiator may be adjusted by controlling the collimator of the X-ray irradiator.

In accordance with another aspect of the present invention, an imaging area setting method of an X-ray imaging apparatus, includes displaying, on a screen, an X-ray image acquired by irradiating an X-ray irradiation area with X-rays, entering a selected-area generation mode to select a partial area of the X-ray image displayed on the screen, setting a selected-area based on a point or area designated on the screen by a user, and displaying the selected-area using a boundary line, and setting the X-ray irradiation area based on the selected-area, and adjusting an X-ray irradiator so as to irradiate the X-ray irradiation area with X-rays.

In accordance with another aspect of the present invention, an X-ray imaging apparatus includes an X-ray irradiator including an X-ray generator to generate X-rays and irradiate an object with the X-rays and a collimator to guide the X-rays, a detector to receive the X-rays having passed through the object and change the X-rays into an electric signal, an image processor to read out an X-ray image from the electric signal of the detector, a display unit to display a screen for the X-ray image to the user, and a controller that receives a selected-area generation instruction to select a partial area of the X-ray image displayed on the screen from the user, displays a selected-area using a boundary line if the selected-area is designated on the screen by the user, sets the X-ray irradiation area based on the selected-area, and adjusts the X-ray irradiator so as to irradiate the X-ray irradiation area with X-rays.

The image processor may perform predetermined image processing on the read out X-ray image for the display unit to display the X-ray image.

The X-ray imaging apparatus may further include a storage unit to store information on the selected-area or the X-ray irradiation area on a per object basis, according to a kind or size of the object.

The controller may control the collimator of the X-ray irradiator to adjust the X-ray irradiator.

The X-ray irradiation area may coincide with the selected-area, or may be an area containing the entire selected-area therein.

The selected-area generation instruction may include a selection instruction to designate at least one selection point on the X-ray image.

The selected-area generation instruction may include a selection instruction to designate plural selection points on the X-ray image, and the controller may set the selected-area based on the selected plural selection points.

The controller may receive a user instruction via an electric signal generated as the user moves a position marker displayed on the screen, or an electric signal generated as the user touches a touchscreen of a display unit coupled or connected to the X-ray imaging apparatus.

In accordance with a further aspect of the present invention, an X-ray imaging apparatus includes an X-ray irradiator including an X-ray generator to generate X-rays and irradiate an object with X-rays and a collimator to guide the X-rays, a detector to receive the X-rays having passed through the object and change the X-rays into an electric signal, an image processor to read out an X-ray image from the electric signal of the detector, a display unit including a touchscreen to display the X-ray image to the user and receive an instruction according to a user touch action, and a controller that receives a selection instruction to designate at least one selection point on the X-ray image according to the user touch action on the touchscreen, sets a selected-area based on the at least one selection point, displays the set selected-area using a boundary line, sets the X-ray irradiation area based on the selected-area, and adjusts the X-ray irradiator so as to irradiate the X-ray irradiation area with X-rays.

The controller may control the collimator of the X-ray irradiator to adjust the X-ray irradiator.

The X-ray irradiation area may coincide with the selected-area, or may be an area containing the entire selected-area therein.

The X-ray irradiation area may be determined by increasing a size of the selected-area by adding a predetermined margin value to a distance between a center of the X-ray image and at least one point of the selected-area.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a view illustrating the entire configuration of an X-ray imaging apparatus according to an embodiment of the present invention;

FIG. 2 is a block diagram of an X-ray imaging apparatus according to an embodiment of the present invention;

FIG. 3 is an exploded side view illustrating an X-ray irradiator and a collimator according to an embodiment of the present invention;

FIG. 4 is an exploded side view illustrating an X-ray irradiator and a collimator according to another embodiment of the present invention;

FIG. 5 is a block diagram of an X-ray imaging apparatus according to an embodiment of the present invention;

FIG. 6 is a view illustrating one example of an X-ray image displayed on a screen according to an embodiment of the present invention;

FIG. 7 is a view explaining an irradiation area according to an embodiment of the present invention;

FIG. 8 is a block diagram of an X-ray imaging apparatus according to another embodiment of the present invention;

FIG. 9 is a flowchart illustrating an imaging area setting method according to an embodiment of the present invention;

FIGS. 10A and 10B are views illustrating an X-ray image display method according to an embodiment of the present invention;

FIG. 11 is a flowchart illustrating an X-ray imaging area setting method according to an embodiment of the present invention;

FIGS. 12A to 12C are views explaining a procedure of designating a selected-area of an X-ray image according to an embodiment of the present invention;

FIG. 13 is a view explaining a selected-area according to an embodiment of the present invention;

FIGS. 14A to 14D are views explaining a procedure of designating a selected-area of an X-ray image according to another embodiment of the present invention;

FIGS. 15A to 15D are views explaining a procedure of designating a selected-area of an X-ray image according to another embodiment of the present invention; and

FIG. 16 is a flowchart illustrating an X-ray imaging area setting method using a touchscreen according to another embodiment of the present invention.

### DETAILED DESCRIPTION

Reference will now be made in detail to the embodiments of the present invention, examples of which are illustrated in the accompanying drawings, wherein like reference numerals refer to like elements throughout.

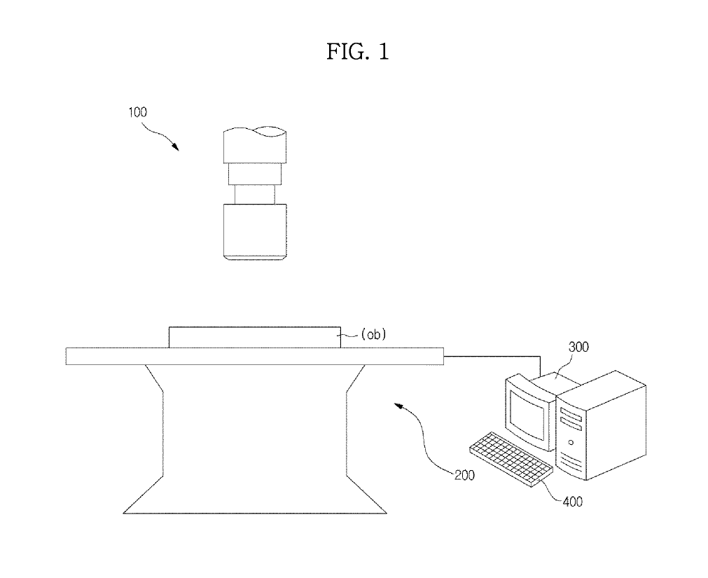

To explain the embodiments of the present invention with reference to FIGS. 1 to 16, first, an X-ray imaging apparatus will be described with reference to FIGS. 1 to 8.

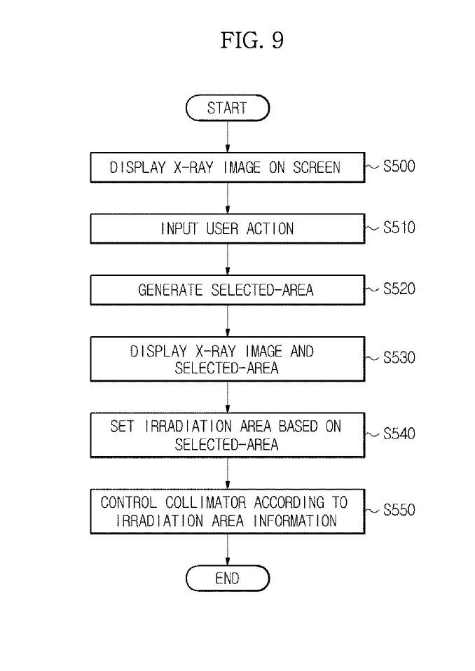

Subsequently, a method of setting a selected-area using an X-ray imaging apparatus and a method of setting an X-ray irradiation area based on the selected-area and controlling a collimator based on the irradiation area according to various other embodiments of the present invention will be described with reference to FIGS. 9 to 16.

Hereinafter, the X-ray imaging apparatus according to the embodiment of the present invention will be described with reference to FIGS. 1 to 7.

FIG. 1 is a view illustrating the entire configuration of the X-ray imaging apparatus according to the embodiment of the present invention.

As illustrated in FIG. 1, according to the embodiment of the present invention, the X-ray imaging apparatus may include an X-ray irradiator 100 to generate X-rays and irradiate an object, designated as ob, with the X-rays. The X-ray imaging apparatus may further include an X-ray detector 200 including an X-ray detection panel to receive the X-rays generated by the X-ray irradiator 100 and to detect X-rays having passed through or absorbed by the object ob. The X-ray imaging apparatus may further include a display unit 300 to generate an X-ray image from an electric signal detected by the X-ray detector 200 or to display an X-ray image generated by the X-ray detector 200 on a screen. The display unit 300 may include a LCD (liquid crystal display), OLED, PDP (plasma display panel), or CRT (cathode ray tube), and the like, for example.

In the X-ray imaging apparatus according to an embodiment of the present invention as illustrated in FIG. 1, the X-ray detector 200 may have a table form and the object ob may be placed on an upper end of the X-ray detector 200. However, the embodiment of the present invention is not limited to the X-ray imaging apparatus having the above-described configuration, and may be applied to various other X-ray imaging apparatuses to acquire an X-ray image by irradiating an object ob with X-rays, such as, for example, an FFDM apparatus and a CT apparatus. For example, the X-ray irradiator 100 and X-ray detector 200 may be oriented in various directions (horizontal, vertical, diagonal, etc.) and need not necessarily be orthogonal or perpendicular to one another. The display unit 300 may be connected to the X-ray detector 200 and/or the X-ray irradiator 200 over a wired or wireless network, or a combination thereof.

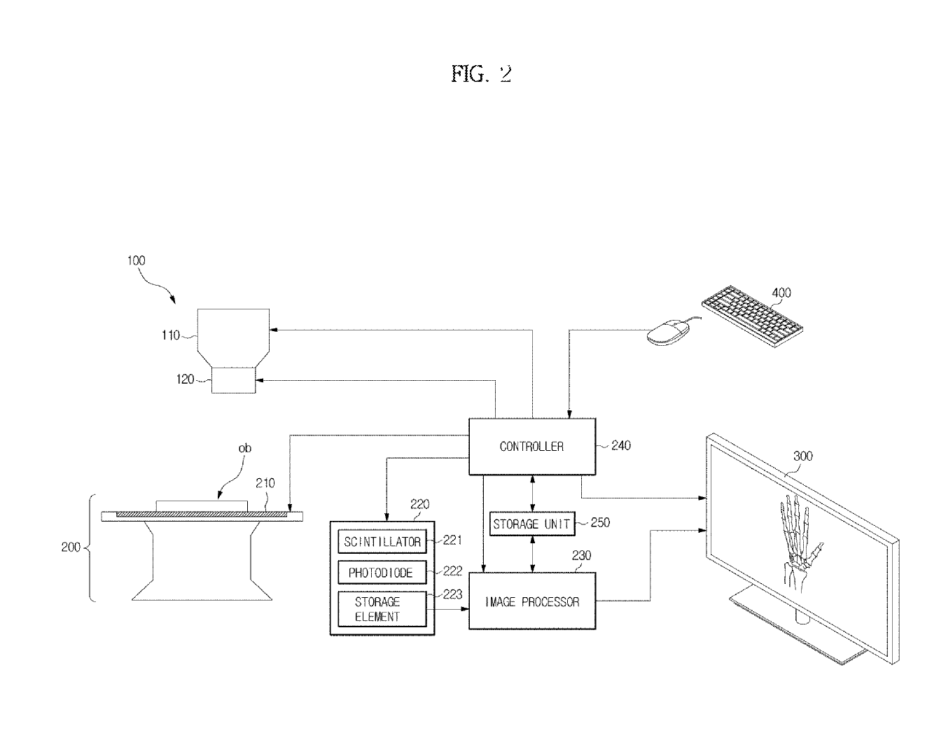

FIG. 2 is a block diagram of the X-ray imaging apparatus according to the embodiment of the present invention.

Referring to FIG. 2, in the embodiment of the present invention, the X-ray irradiator 100 of the X-ray imaging apparatus includes an X-ray generator 110 including an X-ray tube to generate X-rays, and an X-ray irradiation control device 120 to control an irradiation direction or irradiation range of the generated X-rays.

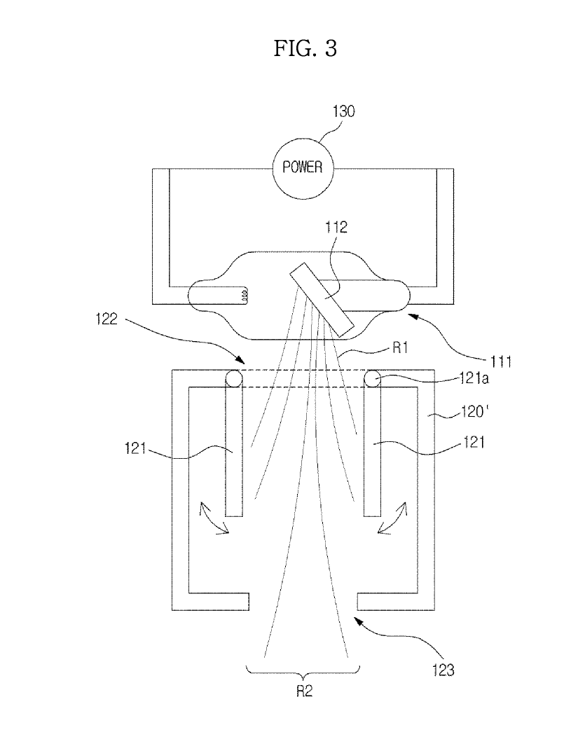

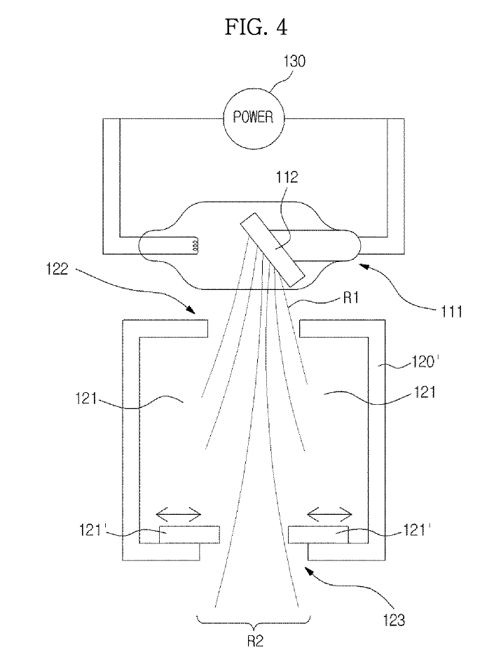

FIGS. 3 and 4 are exploded side views illustrating an X-ray irradiator and a collimator according to various embodiments of the present invention.

Specifically, according to an embodiment of the present invention, the X-ray generator 110, as illustrated in FIG. 3 or 4, may include an X-ray tube 111 to generate X-rays corresponding to a voltage applied thereto, and a power source 130 connected to the X-ray tube 111 to apply a predetermined voltage to the X-ray tube 111.

More specifically, if a predetermined voltage is applied from the power source 130 to the X-ray tube 111, electrons are accelerated within the X-ray tube 111 according to the applied voltage. As the accelerated electrons near the nucleus of an atom are reduced in speed by Coulomb force, X-rays are generated and emitted by the principle of conservation of energy.

Considering the X-ray tube 111 illustrated in FIG. 3 or 4 in more detail, a cathode filament may be located at the left side of the X-ray tube 111, and an anode 112 may be located at the center of the X-ray tube 111.

Electrons are accelerated in the cathode filament according to voltage applied to both distal ends of the X-ray tube 111, and the electrons are reduced in speed due to collision with the center anode. In this case, X-rays are generated from the anode and are irradiated in a predetermined direction, e.g., downward as illustrated in FIGS. 3 and 4.

In the embodiments of the present invention, as illustrated in FIGS. 3 and 4, the X-ray irradiation control device 120 may be coupled to the X-ray generator 110 in an X-ray irradiation direction, more particularly, at a lower end of the X-ray generator 110 in FIGS. 3 and 4.

The X-ray irradiation control device 120 may function to guide X-ray irradiation from the above-described X-ray generator 110 in a particular direction within a partial range.

According to an embodiment of the present invention, the X-ray irradiation control device 120, for example, may be embodied as a collimator 120′ as illustrated in FIGS. 3 and 4.

The collimator 120′ may refer to a device that controls X-rays generated by the X-ray generator 110 via, e.g., filtering, to guide X-ray irradiation in a particular direction within a particular range.

It is noted that X-rays generated by the X-ray generator 110 are not directed only in a direction and range that the user desires. Also, even if X-rays are directed in a particular direction within a particular range, it may be necessary to reduce the irradiation range of X-rays generated by the X-ray generator 110, for example, when an object is small or when it is desired to irradiate X-rays to only a local area of an object.

The collimator 120′ may control an X-ray irradiation direction, e.g., toward the object ob or toward the X-ray detector 200, and may control an X-ray irradiation range to achieve a wide or narrow irradiation range.

To determine the X-ray irradiation direction or irradiation range, the collimator 120′ may perform X-ray filtering using a lead (Pb) collimator filter or at least one collimator blade.

According to an embodiment of the present invention, the collimator 120′, as illustrated in FIG. 3, may include a housing, a plurality of Pb blades 121 to absorb X-rays, an entrance 122 for introduction of X-rays generated by the X-ray generator 110, and an exit 123 for discharge of X-rays having passed through the collimator 120′, rather than being absorbed by the plurality of blades 121. For example, as shown in FIG. 3 and FIG. 4, R1 may refer to X-rays introduced to and/or entering the collimator 120′, and R2 may refer to X-rays discharged from and/or exiting the collimator 120′.

In this case, each of the blades 121 according to the embodiment of the present invention, as illustrated in FIG. 3, may be hinged, at a distal end thereof, to the housing so as to be pivoted by a predetermined angle. For example, a hinge 121a may be formed on the housing to enable at least one blade from among the blades 121 to pivot by a predetermined angle.

According to an embodiment of the present invention, the plurality of blades 121 may be provided to determine an irradiation range of X-rays having passed through the collimator 120′.

The collimator 120′ may move the plurality of blades 121 in response to an external control instruction, such that unhinged ends of the plurality of blades 121 are pivoted about a hinge axis so as to approach each other, which may reduce an X-ray passage path. As such, of X-rays R1 introduced into the collimator 120′, some X-rays passing through the collimator 120′ in a path close to each blade 121 are absorbed by the blade 121, such that only some X-rays R2 of the introduced X-rays R1 are discharged through the exit 123. That is, the number of X-rays R2 is less than the number of X-rays R1 since some of the X-rays R1 are absorbed by the blades 121. As a result, an X-ray passage path within the collimator 120′ is reduced in width, which also reduces an X-ray irradiation area. That is, as the plurality of blades 121 approach one another the number of X-rays R2 decreases since the X-ray passage path is reduced.

On the contrary, if the unhinged ends of the plurality of blades 121 are pivoted about a hinge axis so as to be moved away from each other, a great part of the introduced X-rays R1 is not absorbed by the blades 121 and is discharged through the collimator 120′, which enables irradiation of X-rays within a wide range. That is, as the plurality of blades 121 move away from one another the number of X-rays R2 increases since the X-ray passage path is increased.

Consequently, an X-ray irradiation range may be adjusted (controlled) via the collimator 120′. The hinge/blade arrangement shown in FIG. 3 is only an example and is not intended to be limiting. That is, the hinge 121a may be disposed on other portions of the housing (e.g., a top portion of the collimator 120′, the side portions of the collimator 120′, or the bottom portion of the collimator 120′). The blades may pivot about the hinges such that the X-ray irradiation range may be adjusted accordingly.

According to another embodiment of the present invention, as illustrated in FIG. 4, blades 121′ of the collimator 120′ may be arranged by a predetermined angle with respect to an X-ray passage path within the collimator 120′. For example, the blades 121′ may be arranged perpendicular to the X-ray passage path. As such, the blades 121′ may be moved in a predetermined direction, for example, in a direction perpendicular to the X-ray passage path, which may reduce the width of the X-ray passage path.

That is, as illustrated in FIG. 4, the blades 121′ may reduce the magnitude of an X-ray passage path, along which the blades 121′ are moved in a predetermined direction, for example, in a direction perpendicular to an X-ray irradiation direction within the collimator 120′. For example, the magnitude of the exit 123 may be reduced by moving the blades 121′ in a predetermined direction (e.g., toward one another), thereby allowing only some of the introduced X-rays R1 irradiated in a particular direction within a particular range, i.e. the X-rays R2 to pass through the collimator 120′.

As described above with respect to the collimator of FIG. 4, this results in a controllable (adjustable) irradiation range of X-rays. The blade arrangement shown in FIG. 4 is only an example and is not intended to be limiting. That is, the blades 121′ may be disposed on other portions of the housing (e.g., a top portion of the collimator 120′, such that the blades may move in a predetermined direction to reduce the magnitude of the X-ray passage path in order to adjust the X-ray irradiation range accordingly.

Through the collimator 120′ as described above, X-rays may be directed in a particular direction within a particular range under control, and thus may not be directed to an unnecessary area, which may expose an object to less radiation and allow X-ray irradiation to be focused on a required X-ray imaging area, for example, on an area of an object where a disease is believed to be located, resulting in an increased X-ray imaging resolution. Further, the collimator of FIG. 3 and FIG. 4 may be combined such that some blades are pivotable about a hinge and some blades are arranged by a predetermined angle with respect to an X-ray passage path (e.g., perpendicular to the X-ray passage path).

Referring again to FIG. 2, according to an embodiment of the present invention, the X-ray detector 200 of the X-ray imaging apparatus may include an X-ray detection panel 210 to receive X-rays irradiated from the X-ray irradiator 100 and to detect X-rays having passed through or absorbed by the object ob.

The X-ray detection panel 210 may include a plurality of pixels 220 that detect X-rays and change the detected X-rays into an electric signal, to allow an image processor 230 that will be described hereinafter to read out an X-ray image using the electric signal.

In an embodiment of the present invention, as illustrated in FIG. 2, each of the plurality of pixels 220 of the X-ray detection panel 210 includes light receiving elements 221 and 222 (for example, a scintillator and photodiode) to receive X-rays having passed through or absorbed by the object and to change the X-rays into an electric signal, and a storage element 223 electrically connected to the light receiving elements 221 and 222 to temporarily or semi-permanently store the electric signal changed by the light receiving elements 221 and 222.

In an embodiment of the present invention, as illustrated in FIG. 2, the light receiving elements 221 and 222 of any one pixel 220 may include a scintillator to output visible photons upon receiving X-rays, and a photodiode to generate an electric signal upon sensing the photons output from the scintillator. The photodiode adapted to generate an electric signal of an X-ray image via light sensing may be mounted to a light processor attached to the scintillator 221, for example, a Complementary Metal Oxide Semiconductor (CMOS) chip.

In other words, if X-rays are generated, the scintillator 221 of each pixel 220 of the X-ray detection panel 210 included in the X-ray detector 200 outputs photons upon receiving X-rays, and the photodiode changes the output photons into an electric signal after sensing the photons. Then, the storage element electrically connected to the photodiode, for example, a capacitor, stores the output electric signal, to assist the image processor 230 in generating an X-ray image.

In an embodiment of the present invention, the X-ray detector 200, as illustrated in FIG. 2, may further include the image processor 230.

The image processor 230 generates X-ray image data for an image to be displayed on the display unit 300 by reading out an X-ray image from each electric signal of the X-ray detector 200 and by performing predetermined image processing, for example, post-treatments such as correction of color and brightness, on the readout X-ray image.

In this case, the image processor 230 may allow the image to be displayed on the display unit 300, or to be stored in a separate storage unit 250, for example, in a memory device. The storage unit 250 or memory device may be embodied as, for example, non-transitory computer-readable media including magnetic media such as hard disks, floppy disks, and magnetic tape; optical media such as CD ROM disks and DVDs; magneto-optical media such as optical discs; and hardware devices such as read-only memory (ROM), random access memory (RAM), flash memory, USB memory, and the like.

In an embodiment of the present invention, the X-ray imaging apparatus may further include a controller 240. The controller may be included in any one of the X-ray irradiator 100, X-ray detector 200, display unit 300/310, and/or input unit 400, for example. The controller may be included in a computer, for example, and may communicate with and/or control operations of, the X-ray irradiator 100, X-ray detector 200, display unit 300/310, and/or input unit 400, as well as the storage unit 250, image processor 230, for example.

The controller 240 may control the above-described X-ray irradiator 100 so as to control voltage to be applied to the X-ray tube of the X-ray generator 110 according to an energy level of X-rays, or may control the X-ray irradiation control device 120, for example, the collimator, so as to control an X-ray irradiation direction or irradiation range from the X-ray irradiator 100.

Additionally, the controller 240 may control the X-ray detector 220, for example, each pixel 220 of the X-ray detection panel 210, so as to control an operation of the scintillator 221 or the storage element 223.

Additionally, the controller 240 may transmit a control instruction to the above-described image processor 230, so as to assist the image processor 230 in reading out an X-ray image from the electric signal stored in the storage element 223 and performing predetermined image processing on the read-out X-ray image. The controller 240 may also control display of the X-ray image, generated by the image processor 230, on the display unit 300.

According to an embodiment of the present invention, the controller 240 may correct an X-ray image to be displayed on the display unit 300 in response to a user instruction input via an input unit 400. The controller 240 may control the X-ray irradiation control device 120, for example, the collimator according to the corrected X-ray image. The input unit 400 may be embodied by, for example, an apparatus or device such as a keyboard, pedal or footswitch, mouse, touchscreen, graphical user interface, or voice control or microphone, or combinations thereof, to enable a user to provide an instruction via the input unit.

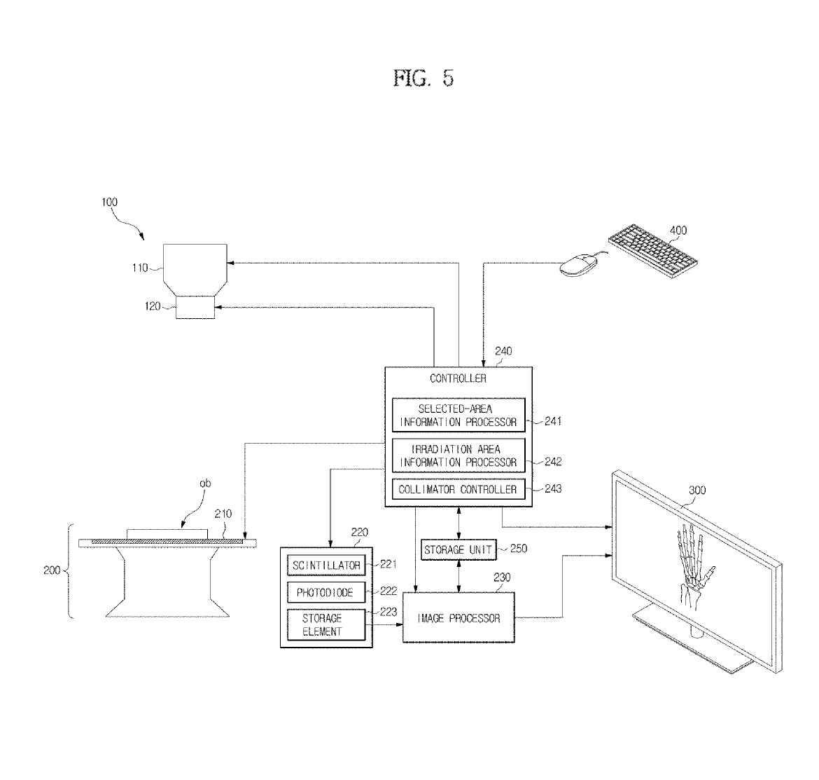

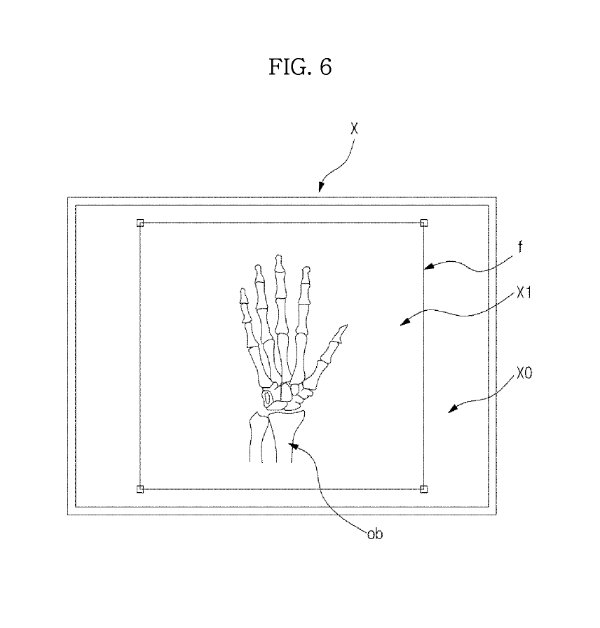

FIG. 5 is a block diagram of the controller according to an embodiment of the present invention, and FIG. 6 is a view illustrating one example of an X-ray image displayed on a screen according to an embodiment of the present invention.

As illustrated in FIG. 5, the controller 240 according to an embodiment of the present invention may include a selected-area information processor 241, an irradiation area information processor 242, and a collimator controller 243.

According to an embodiment of the present invention, the selected-area information processor 241 of the controller 240 receives at least one selected-area generation instruction from a user through the input unit 400. The instruction is required to generate a selected-area of an X-ray image (x in FIG. 6) displayed on a screen of the display unit 300, and the input unit 400 may transmit an electric signal to the controller 240. Then, the selected-area information processor 241 generates a selected-area X1 in response to the selected-area generation instruction.

Here, the selected-area X1 refers to a partial area divided from the other area X0 of the entire area X of an X-ray image displayed on the screen by a boundary line f.

As necessary, the selected-area information processor 241 may store information on the selected-area. For example, the information on the selected-area may be positional information including various coordinate values, such as a coordinate value on the basis of a center point, a coordinate value defined as the magnitude of the selected-area, an X-Y coordinate value, and a 2D or more coordinate value, etc. Alternatively, other coordinate systems may be used, for example, a polar coordinate system.

In an embodiment of the present invention, the selected-area generation instruction is an instruction input by the user to designate a selected-area. The selected-area generation instruction according to an embodiment of the present invention may be a group of instructions including at least one instruction input by the user.

In other words, although the selected-area generation instruction according to an embodiment of the present invention may be a single instruction input by the user, in another embodiment of the present invention, the selected-area generation instruction may include a plurality of instructions generated when the user operates the input unit 400 plural times to generate a selected-area. In this case, the plurality of instructions may be sequentially performed in a sequence set by the user or in a predefined sequence, or may be simultaneously performed, so as to generate a selected-area by selecting a partial area of an X-ray image as described above.

In an embodiment of the present invention, the selected-area generation instruction may include a mode-change instruction to select a partial area of an X-ray image displayed on a screen. In other words, the mode-change instruction may cause the X-ray image apparatus to enter a selected-area generation mode for designation of a selected-area.

Additionally, in an embodiment of the present invention, the selected-area generation instruction may be an instruction to designate at least one selection point on an X-ray image. In one example, the selected-area generation instruction may be generated when the user provides an input (e.g., clicks a selection button of a mouse) in a state in which a position marker, (e.g., a cursor) is located on a position on an X-ray image, and the instruction may be transmitted to the controller 240. In this case, the selected-area generation instruction may be an instruction to designate a position on the screen where the cursor is located as a selection point.

The selected-area generation instruction, according to an embodiment of the present invention, may be an instruction to designate a plurality of selection points.

The controller 240 may designate a selected-area in response to the selected-area generation instruction input by the user, and may display the selected-area on the display unit 300. As necessary, a separate way to divide the selected-area from the other area, for example, a boundary line on the rim of the selected-area may be displayed on the display unit 300.

Through use of the selected-area information processor 241 of the controller 240 as described above, it may be possible for the user to visually select an X-ray irradiation area from an X-ray image in a state in which the X-ray image is displayed on the screen.

More specifically, as illustrated in FIG. 6, according to an embodiment of the present invention, an X-ray image X may be displayed on the display unit 300 or a screen output by a display unit 310 including a touchscreen.

The X-ray image X contains an image of the object ob that is X-rayed (irradiated) by the X-ray irradiator 100.

If the user inputs a selected-area generation instruction via the input device 400, such as by using a keyboard or a mouse or a touchscreen 310 or combination thereof, the above-described selected-area information processor 241 generates a selected-area X1.

The selected-area X1 selected according to an embodiment of the present invention may be defined by a plurality of boundary lines f, for example, four straight lines (which may be connected to form a polygon such as a rectangle) as illustrated in FIG. 6. In this case, the four straight lines as boundary lines, according to an embodiment of the present invention as illustrated in FIG. 6, may be arranged such that the lines facing each other are parallel to each other and the lines not facing each other are perpendicular to each other. Consequently, the selected-area X1, as illustrated in FIG. 6, may be divided from the other area X0 by the rectangular boundary lines f.

Of course, it will be appreciated that according to embodiments of the present invention, the selected-area X1 may be selected from among various shapes, such as, for example, trapezoidal, circular, oval shapes, and other like geometric/polygonal shapes, in addition to the rectangular shape, and the boundary lines f to divide the selected-area X1 from the other area X0 may also have trapezoidal, circular, oval shapes, and other like geometric/polygonal shapes, in addition to the rectangular shape.

According to an embodiment of the present invention, the irradiation area information processor 242 of the controller 240 sets an irradiation area, to which the X-ray imaging apparatus will irradiate X-rays, based on the selected-area generated by the selected-area information processor 241.

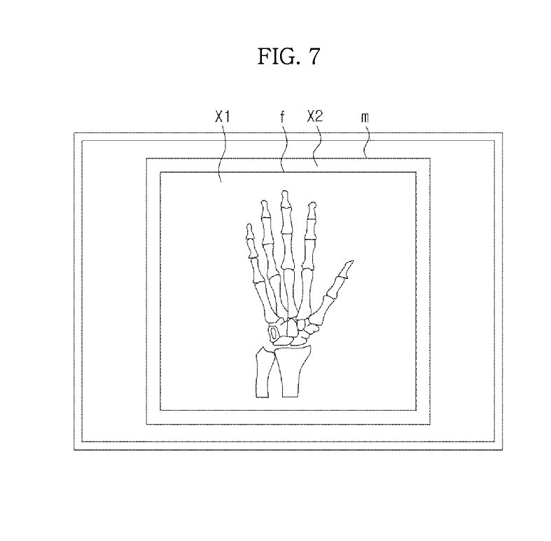

FIG. 7 is a view explaining an irradiation area according to an embodiment of the present invention.

As illustrated in FIG. 7, according to an embodiment of the present invention, the irradiation area information processor 242 may set an X-ray irradiation area X1+X2 such that the X-ray irradiation area X1+X2 contains the entire selected-area X1 that is selected by the user.

That is, the irradiation area information processor 242 may calculate a wider area X1+X2 than the selected-area X1 selected by the user, and set the calculated area X1+X2 to an X-ray irradiation area.

To set the X-ray irradiation area X1+X2, the irradiation area information processor 242 according to an embodiment of the present invention may generate the X-ray irradiation area X1+X2 by increasing the length of each side of the selected-area X1, or by adding a predetermined margin value to a distance between a point of the selected-area and the center of an X-ray image. For example, if the selected area X1 corresponds to a circular shape, the wider area X1+X2 may also correspond to a circular shape, having a radius greater than the radius of the selected area X1 by a predetermined amount.

In this case, it will be appreciated that a boundary line m of the X-ray irradiation area X1+X2 is located around the boundary line f of the selected-area X1.

By setting the X-ray irradiation area X1+X2 so as to be greater than the selected-area X1 selected by the user, X-ray irradiation may be performed within the range X1+X2 that is slightly greater than the selected-area X1, which may prevent imaging failure of a part of the object ob due to unintentional movement of the object, e.g., unintentional movement of hands or feet of the patient.

Of course, it will be appreciated that the irradiation area information processor 242 may set the same X-ray irradiation area X1+X2 as the selected-area X1. That is, the boundary line m of the X-ray irradiation area X1+X2 may coincide with the boundary line f of the selected-area X1. That is, boundary line m may equal boundary line f.

As necessary, according to an embodiment of the present invention, the X-ray irradiation area X1+X2 may be set such that the X-ray irradiation area X1+X2 and the selected-area X1 share a partial area, but any one, e.g., the X-ray irradiation area X1+X2, does not completely include the other one, e.g., the selected-area X1.

The collimator controller 243 of the controller 240 may control the X-ray irradiator 100, more particularly, the X-ray irradiation control device 120 of the X-ray irradiator 100, e.g., the collimator 120′, based on the selected-area displayed on the display unit 300 or the X-ray irradiation area calculated by the irradiation area information processor 242, so as to change the X-ray irradiation area.

In this case, the collimator controller 243 may generate a control instruction to control the above-described collimator 120′, and transmit the control instruction to the collimator 120′ to move the blades 121 of the collimator 120′ about a hinge axis of the collimator 120′, thereby adjusting an X-ray irradiation range.

Alternatively, as necessary, the controller 240 may first judge whether or not an X-ray irradiation range of a previously captured X-ray image differs from the selected-area as described above. In other words, according to an embodiment of the present invention, if the selected-area differs from the previous X-ray irradiation area, the controller 240 may control the X-ray irradiator 100 based on the selected-area, so as to change the X-ray irradiation area.

According to another embodiment of the present invention, the controller 240 may display an X-ray irradiation area setter on the screen of the display unit 300 in response to a display instruction of the X-ray irradiation area setter that is input by the user.

The X-ray irradiation area setter may take the form of various frames defining a linear or curvilinear boundary line to divide a partial area of an X-ray image from the other area, such as, for example, triangular, rectangular (see f in FIG. 6), circular, oval, polygonal, and various other frames having various polygonal or geometric shapes.

In this case, the controller 240 may control display of the X-ray irradiation area setter in the form of various frames such that the X-ray irradiation area setter overlaps the X-ray image displayed on the screen.

According to another embodiment of the present invention, the X-ray irradiation area setter may be a layer overlapping a partial area of an X-ray image to distinguish the partial area from the other area.

In response to a user operating instruction input via the input unit 400, such as a keyboard or mouse, the X-ray irradiation area setter may be moved in a predetermined direction, or the size of the X-ray irradiation area setter, e.g., the height or width of the X-ray irradiation area setter in the form of a rectangular frame may be adjusted.

In this case, the user operating instruction, according to an embodiment of the present invention, may be an instruction generated as the user selects or moves an adjustment point on the above-described boundary line or layer.

In an embodiment of the present invention, the storage unit 250 may store an X-ray image generated by the image processor 230, or information on the selected-area or the irradiation area generated by the controller 240.

In this case, the information on the selected-area or the irradiation area may be separately stored according to the kind or size of the object ob to be x-rayed. In other words, the storage unit 250 may store information on the selected-area or the irradiation area on a per object basis if different X-ray irradiation areas are present for X-ray examination of different parts of the object ob, such as hands and feet of a person.

The above-described controller 240 may control the X-ray irradiator 100 by reading out information on the selected-area or the irradiation area stored in the storage unit 250. In particular, the controller 240 may differently control the X-ray irradiator 100 according to the kind or size of the object ob to be x-rayed.

The input unit 400, according to an embodiment of the present invention, receives at least one selected-area generation instruction to generate a selected-area of an X-ray image displayed on the screen of the display unit 300 from the user.

According to an embodiment of the present invention, the input unit 400 may be a keyboard or mouse, and may be a tablet that receives an instruction according to pressure or static electricity, or a tablet-pen to touch the tablet to input an instruction to the tablet.

The display unit 300 displays the X-ray image generated by the image processor 230 to the user, such as a doctor, nurse, radiologist or patient.

In an embodiment of the present invention, the display unit 300 displays not only the X-ray image, but also the selected-area via an identifier, e.g., the boundary line f on the screen, to assist the user, such as a doctor, nurse, or radiologist in adjusting an imaging area by the X-ray imaging apparatus.

The display unit 300, for example, may display a Graphic User Interface (GUI) along with the boundary line that divides the selected-area from the other area of the X-ray image, for user input convenience.

In an embodiment of the present invention, the display unit 300 may be a monitor mounted to the X-ray detector 200, or may be an external monitor connected to the X-ray detector 200 or an information processing device, such as a computer, connected to the monitor. The display unit 300 may be connected to the X-ray irradiator 100, X-ray detector 200, and/or the input unit 400 via a wired or wireless connection, or a combination thereof.

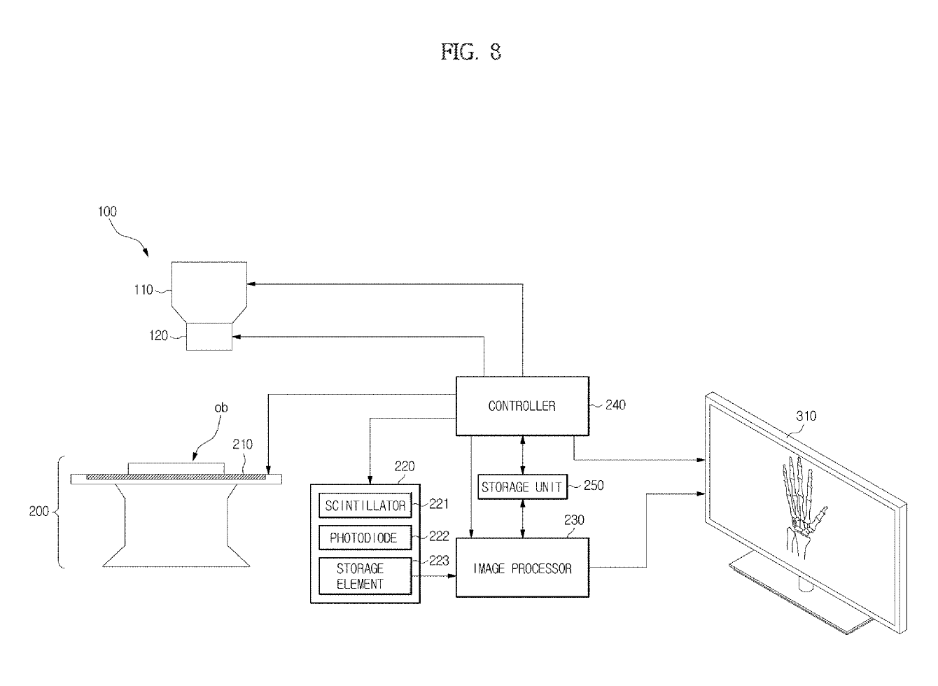

FIG. 8 is a block diagram of an X-ray imaging apparatus according to another embodiment of the present invention.

The X-ray imaging apparatus according to an example embodiment, as illustrated in FIG. 8, may include the X-ray irradiator 100 and the X-ray detector 200. The X-ray imaging apparatus may further include the display unit 310 including a touchscreen, instead of the above-described input unit 400. That is, the functionality which may be achieved by the input unit 400 may be incorporated into or integrated with the display unit using a touchscreen.

The display unit 310 including a touchscreen, in an embodiment of the present invention, may display a boundary line that divides a selected-area of an X-ray image from the other area to the user, such as a doctor, nurse, radiologist or patient. As necessary, the display unit 310 may further display a GUI for user input convenience.

In an embodiment of the present invention, the display unit 310 including a touchscreen may receive an instruction according to a user touch action on the touchscreen, for example, an instruction for selection of the selected-area.

Here, the user touch action on the touchscreen may include a touch action in which the user touches the touchscreen with a finger or a stylus once or plural times, and a touch-and-drag action in which the user touches a position on the touchscreen with the aforementioned touch and may moves the touch while in contact (or substantially in contact) with the touchscreen.

In this case, the selected-area information processor 241 of the controller 240 may generate a selected-area, which is a partial area of an X-ray image displayed on the screen and divided from the other area by a boundary line, based on at least one selection point designated by a selection instruction input via the user touch action on the touchscreen. Then, the selected-area information processor 241 may control display of the selected-area on the touchscreen using a desired display method, for example, the boundary line that divides the selected-area from the other area.

Next, a method of setting an imaging area of the X-ray imaging apparatus according to various embodiments of the present invention will be described with reference to FIGS. 9 to 16.

FIG. 9 is a flowchart illustrating an imaging area setting method according to an embodiment of the present invention.

As illustrated in FIG. 9, the imaging area setting method of the X-ray imaging apparatus according to an embodiment of the present invention may include displaying an X-ray image on a screen (S500), receiving an operating instruction input by a user (S510), generating a selected-area in response to the operating instruction (S520), displaying both the X-ray image and the selected-area (S530), setting an irradiation area based on the selected-area (S540), and controlling a collimator according to information on the irradiation area (S550).

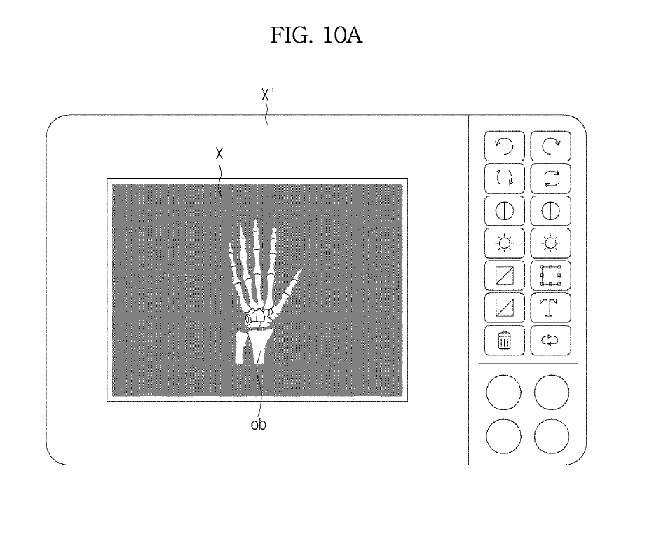

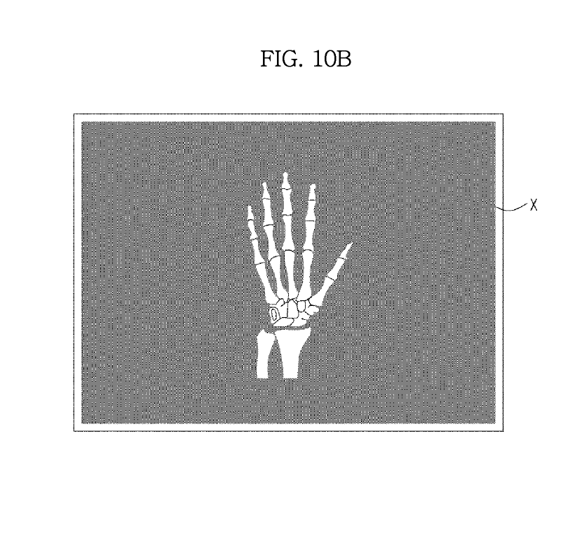

Explaining the imaging area setting method of the X-ray imaging apparatus in detail, first, an X-ray image of an object ob is captured by the X-ray imaging apparatus. In this case, as described above, if the X-ray irradiator 100 irradiates the object ob with X-rays, the X-ray detector 200 generates an X-ray image using the X-ray detection panel 210 and the image processor 230. The X-ray image may be displayed on the screen of the display unit 300, for example, as illustrated in FIG. 10A (S500).

FIGS. 10A and 10B are views illustrating a method of displaying an X-ray image according to an embodiment of the present invention.

As illustrated in FIG. 10A, the X-ray image may be displayed to the user via the display unit 300 or the display unit 310 including a touchscreen. For example, the X-ray image may include an image part X read out from a partial region of the X-ray detection panel 210 to which X-rays are irradiated, and an image part X′ readout from a partial region of the X-ray detection panel 210 to which X-rays are not irradiated. In general, the X-ray image of the object ob may be displayed in the image part X read out from the partial region to which X-rays are irradiated.

In addition, according to an embodiment of the present invention, the display unit 300 or 310 may further display a GUI for user convenience. As shown in FIG. 10A for example, a plurality of buttons, icons, or objects may be displayed on the screen representing a function which may be performed with respect to the X-ray image. For example, a user may select one or more of the buttons, icons, and/or objects to modify or edit the X-ray image (for example, rotating the image, increasing a brightness of the image, adding text to an image, etc.).

Hereinafter, to ensure clear description of the embodiment of the present invention without undue complexity, the embodiment of the present invention will be described based on the image part X readout from the partial region to which X-rays are irradiated as illustrated in FIG. 10B.

If the X-ray image is displayed on the screen, the controller 240 receives an instruction for generation of a selected-area from the user in a state in which the X-ray image is displayed (S510).

In this case, the instruction for generation of a selected-area includes an instruction to enter a selected-area generation mode for selection of a partial area of an X-ray image, or an operating instruction to select a selected-area X1 as a partial area of an X-ray image X.

According to an embodiment of the present invention, prior to receiving at least one operating instruction for designation of a selected-area from the user, it may be possible to enter a selected-area generation mode for designation of a selected-area.

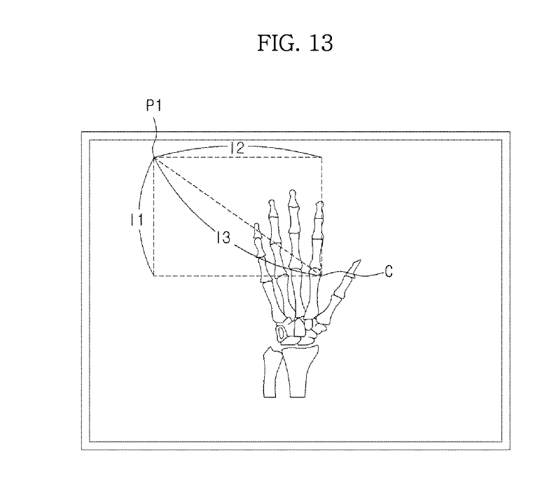

After entering the selected-area generation mode, according to an embodiment of the present invention, the user may input an operating instruction to select the selected-area X1 as a partial area of the X-ray image X. For example, the user may provide the input through the input unit 400 or display unit 310 (e.g., using a mouse, keyboard, tablet, or a tablet-pen). A method of selecting the selected-area X1 to which the user desires to irradiate X-rays will hereinafter be described with reference to FIGS. 13A to 16.

Then, the controller 240 generates the selected-area X1 in response to a user action (S520). That is, the controller 240 receives information on the selected-area X1, for example, all or some of the size of the selected-area X1 and coordinate values of boundary lines in response to a user action, and generates the selected-area X1 based on the size of the selected-area X1 or the coordinate values. In this case, the controller 240 may acquire only a part of information on the selected-area X1 from the user, and may acquire other required information via additional calculation.

That is, for example, the controller 240 may receive an instruction to select at least one point which corresponds to a point on the boundary line f of the selected-area X1, and calculate a distance between the at least one point on the boundary line f of the selected-area X1 and a coordinate value of the center of the X-ray image, thereby calculating a polygon, one angular point of which is the at least one point on the boundary line f, for example, a rectangular selected-area X1 as illustrated in FIG. 6. Alternatively, the controller 240 may calculate a circular selected-area X1, a radius of which is the distance between the at least one point on the boundary line f and a coordinate value of the center of the X-ray image.

Consequently, it may be possible for the user to select an area of the X-ray image X to which the X-ray irradiator 100 will irradiate X-rays.

After the selected-area X1 is generated according to a user action, the X-ray image X and the selected-area X1 may be simultaneously displayed on the display unit 300, 310 (S530).

According to an embodiment of the present invention, the selected-area X1 may be displayed, using the boundary line f, on the display unit 300, 310, for distinction between the selected-area X1 and the other area X0. In this case, the boundary line f may be a line or curve having a constant thickness, or a combination of a line and curve. According to an embodiment of the present invention, for clear distinction between the selected-area X1 and the other area X0, the boundary line f may have a different color from the X-ray image X. For example, if the X-ray image X is a black-and-white image, the boundary line may be white. If the X-ray image is subjected to colorization into a desired color, the boundary line f may be displayed as a color image.

According to another embodiment of the present invention, the selected-area X1 may be displayed using a layer that divides the selected-area X1 from the other area X0 and overlaps the X-ray image X, for example, a predetermined shape of layer having a different color from that of the other area X0.

Subsequently, the controller 240 sets an X-ray irradiation area X1+X2 based on the selected-area X1 selected by the user (S540). In this case, the X-ray irradiation area X1+X2 may completely include the selected-area X1. To set the X-ray irradiation area X1+X2, the irradiation area information processor 242 of the controller 240 may generate the X-ray irradiation area X1+X2 by increasing the length of each side of the selected-area X1, or by adding a predetermined margin value to a distance between each point of the selected-area and the center of the X-ray image. Of course, the same X-ray irradiation area X1+X2 as the selected-area X1 may be set. That is, the irradiation area may automatically be determined using the predetermined margin value or by adding a predetermined amount to each side, without a user actively selecting the X-ray irradiation area X1+X2.

Once the X-ray irradiation area X1+X2 has been set, setting information on the X-ray irradiation area X1+X2 is stored in the storage medium 250. In this case, the selected-area X1 or the X-ray irradiation area X1+X2 may be separately stored on a per object basis. In other words, various setting information on the selected-area X1 or the X-ray irradiation area X1+X2 may be stored in the storage medium according to, e.g., the kind or size of the object ob. Thus, a lookup table may be formed, for example, by establishing a correspondence between the selected-area X1 or the X-ray irradiation area X1+X2 with a type or size of object.

In an embodiment of the present invention, the controller 240 controls the X-ray irradiation control device 120, e.g., the collimator according to information on the X-ray irradiation area X1+X2 calculated and stored as described above, thereby determining an X-ray irradiation range (S550). Accordingly, as necessary, the controller 240 may control the X-ray irradiation control device 120 by reading out setting information corresponding to the object from among various setting information on the selected-area X1 or the X-ray irradiation area X1+X2 that is stored in the storage unit 250 according to, e.g., the kind or size of the object ob to be x-rayed.

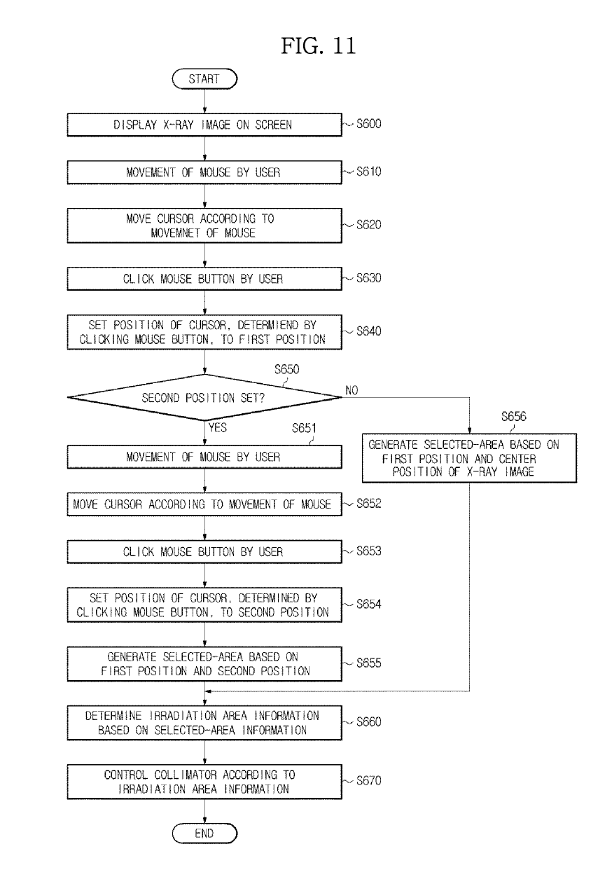

Hereinafter, various embodiments of an X-ray imaging area setting method will be described with reference to FIGS. 11 to 15.

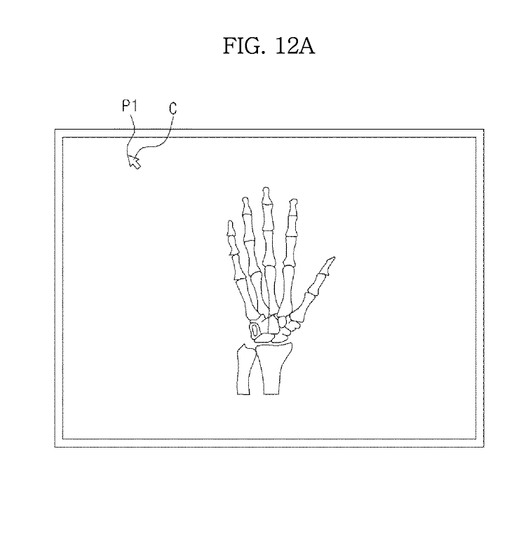

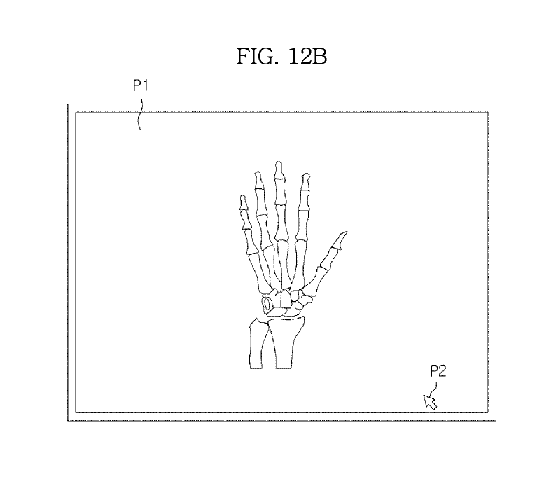

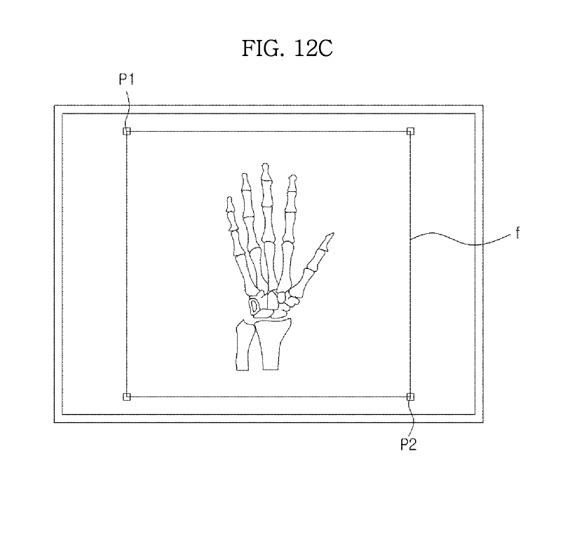

FIG. 11 is a flowchart illustrating an X-ray imaging area setting method according to an embodiment of the present invention, and FIGS. 12A to 12C are views explaining a procedure of designating a selected-area of an X-ray image according to an embodiment of the present invention.

The X-ray imaging area setting method illustrated in FIG. 11 according to an embodiment of the present invention may be performed by the X-ray imaging apparatus that receives a user instruction via the input unit, such as a keyboard, mouse, tablet, or tablet-pen, as illustrated in FIG. 2.

As illustrated in FIG. 11, in the X-ray imaging area setting method according to the embodiment of the present invention, first, an X-ray image X captured by the X-ray imaging apparatus is displayed on the screen of the display unit 300 included in the X-ray imaging apparatus (S600).

The user operates the input unit (e.g., a keyboard, mouse, tablet, or stylus), to directly designate a selected-area X1 over the X-ray image X displayed on the screen of the display unit 300 (S610). Here, the user action may include, for example, moving a mouse, or pushing directional keys of a keyboard. Through the user action using the input unit (e.g., a mouse, keyboard, tablet, or stylus), a position marker displayed on the screen of the display unit 300, for example, a cursor c, is moved to a position p1 selected by the user, for example, a first position P1 as illustrated in FIG. 12A (S620).

Then, if the user provides an input to the input unit (e.g., clicks a selection button, for example, a left or right button of the mouse or a certain button on the keyboard) at the first position of the cursor c (S630), a position of the position marker, i.e. the cursor c, is set to the first position when providing the input (e.g., clicking the left or right button of the mouse or the certain button on the keyboard) (S640).

As illustrated in FIG. 11, according to an embodiment of the present invention, after the first position P1 is set, a polygon, any one angular point of which is the first position P1, for example, a rectangle may be set to the selected-area X1 (S656).

FIG. 13 is a view explaining a selected-area according to an embodiment of the present invention.

Referring to FIG. 13, in an embodiment of the present invention, information on the first position P1 may be represented by coordinate values I1 and I2 of the first position P1 on the basis of a center position C of the X-ray image. That is, the center position C of the X-ray image may correspond to a reference point from which coordinate points for the first position P1 may be derived. For example, the center position C of the X-ray image may correspond to the origin having a coordinate value of (0,0) in a 2-dimensional Cartesian coordinate system. However, the disclosure is not so limited and other variations are possible within the ordinary skill of one in the art.

Once the first position P1 has been set by the user, a vertical distance I1 and a horizontal distance I2 between the first position P1 and the center position C of the X-ray image may be calculated. The vertical distance I1 and the horizontal distance I2 may be used as coordinate values of the first position P1.

According to an embodiment of the present invention, a rectangular selected-area X1 may be acquired using coordinate values of the first position P1. To this end, by calculating information on a position of another angular point of the rectangle based on the coordinate values I1 and I2 of the first position P1 on the basis of the center position C of the X-ray image, coordinate values of a position of each angular point, for example, −I1 and −I2 may be acquired. As such, the rectangular selected-area X1 may be acquired using the coordinate values of the first position P and the coordinate values of positions of the other angular points.

Consequently, as illustrated in FIG. 12C, the selected-area X1 defined by the boundary line f may be acquired.

In another embodiment of the present invention, referring to FIG. 13, information on a position of another angular point, for example, I3 and −θ may be calculated using a distance (e.g., a straight line distance) I3 between the center position C of the X-ray image and the first position P1 and an angle θ between a reference line, for example, a line passing through the center position C and a line passing through both the first position P1 and the center position C, and then the rectangular selected-area X1 may be set using the coordinate values of positions of the other angular points.

In a further embodiment of the present invention, the selected-area X1 may be set by assuming that any one point on a circle or an oval is the first position P1. In this case, the circular selected-area X1, which has a radius corresponding to a distance I3 between the center position C of the X-ray image and the first position P1, may be set. Alternatively, the distance I3 between the center position C of the X-ray image and the first position P1 may be used to calculate a distance of one of the major/minor axis diameters of an oval or ellipse selected-area X1, with the other minor/major axis diameter being a predetermined multiple of the first calculated distance.

According to an embodiment of the present invention, as illustrated in FIGS. 11 and 12B, a second position may be set (S650).

As illustrated in FIGS. 11 and 12B, the user moves a position marker, for example, a cursor from the first position P1 to another position by operating the input unit (e.g., a mouse or keyboard) (S652), and thereafter provides another input (e.g., clicks a predetermined button, for example, a mouse button) (S653). A position where the user operates or provides the another input (e.g., clicks the predetermined button) is set to the second position P2.

Then, as illustrated in FIGS. 11 and 12C, the selected-area is set using the first position P1 and the second position P2 (S655). In particular, when the selected-area is displayed on the screen, for distinction with the other area, the boundary line f may also be displayed as illustrated in FIG. 12C.

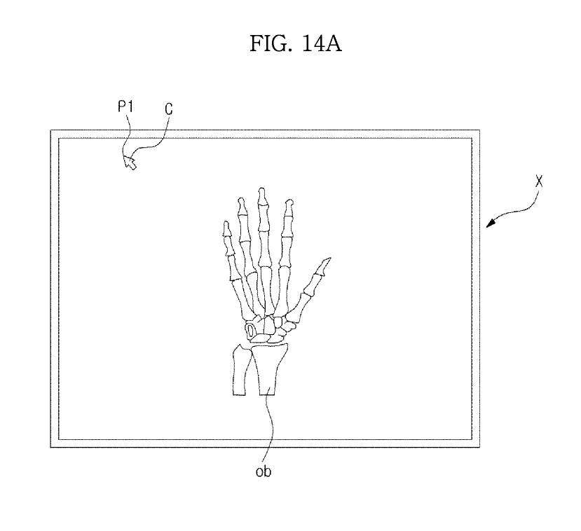

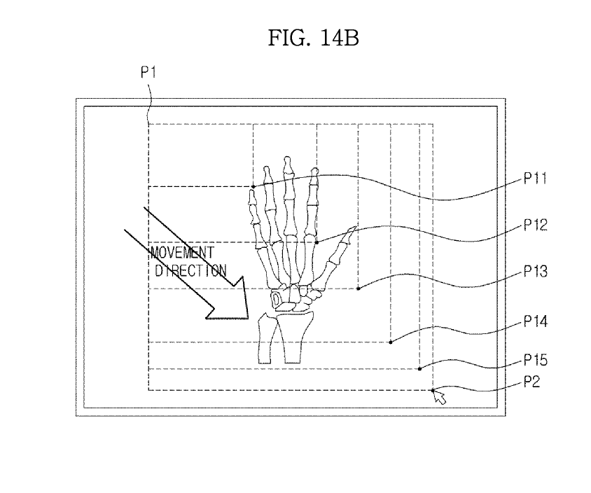

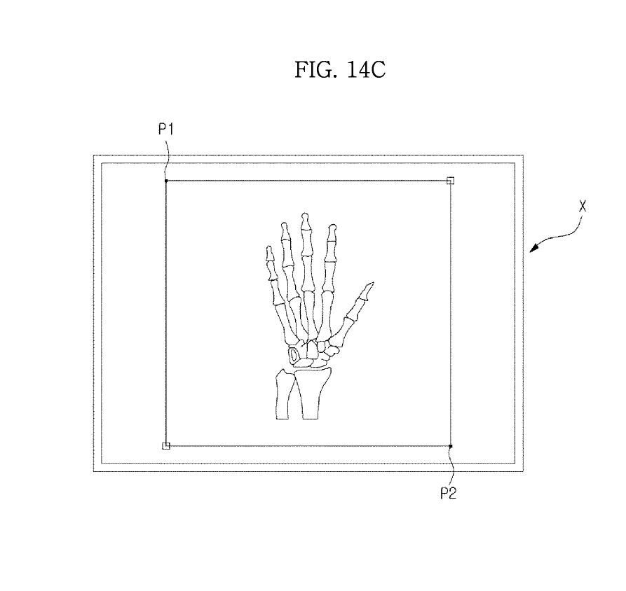

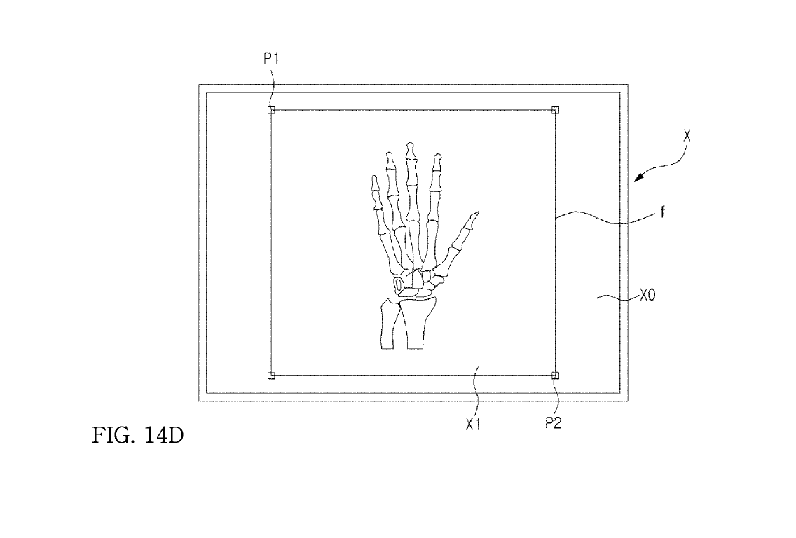

According to another embodiment of the present invention, as illustrated in FIGS. 14A to 14D, a selected-area may be set via a user drag action.

FIGS. 14A to 14D are views explaining a procedure of designating a selected-area of an X-ray image according to another embodiment of the present invention.

First, as illustrated in FIG. 14A, the user locates a position marker, for example, a cursor C at a position of an X-ray image X by operating the input unit (e.g., a mouse, keyboard, tablet, or a stylus). Then, if the user provides another input (e.g., pushes a predetermined selection button on the mouse or keyboard), the position where the cursor C is located is set to a first position P1 (S640).

In this case, the user may drag the position marker C in a desired movement direction as illustrated in FIG. 14B. The drag action, for example, may be realized by a predefined input command or predetermined input pattern using the input unit (e.g., moving the mouse in a desired movement direction or by operating a directional key of the keyboard while continuously pushing the predetermined selection button on the mouse or keyboard). Through implementation of the user drag action using the input unit (e.g., a mouse or keyboard), the position marker C is moved to pass a plurality of points P11 to P15 and P2. If the user finishes the drag action at a desired point after movement of the position marker C, for example, if the user removes the finger from the selection button of the mouse, the desired point where the drag action is finished is set to a second position P2 as illustrated in FIG. 14B (S650 to S654).

The controller 240 generates, i.e., sets the selected-area X1, based on the first position P1 and the second position P2 set by the above-described drag action as illustrated in FIG. 14C (S655).

For example, the controller 240, as illustrated in FIG. 14C, may generate a rectangular selected-area X1 in which the first position P1 and the second position P2 serve as angular points facing each other. Alternatively, for example, a circle or ellipse selected-area X1 may be generated by using a line or segment formed between the positions P1 and P2 to form a diameter of the circle or ellipse.

Then, the selected-area X1 is displayed to the user via the display unit 300.

In this case, according to an embodiment of the present invention, as illustrated in FIG. 14D, the boundary line f to distinguish the selected-area X1 from the other area X0 may also be displayed.

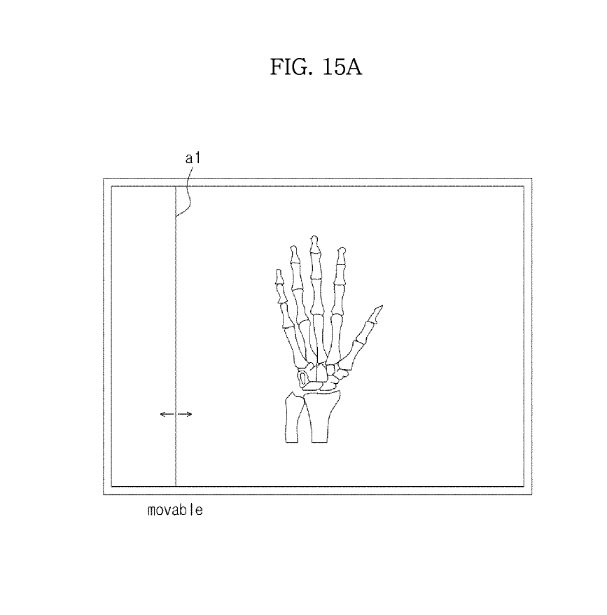

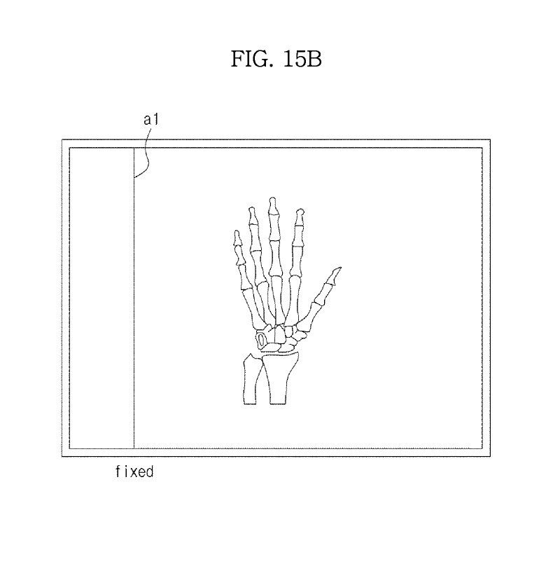

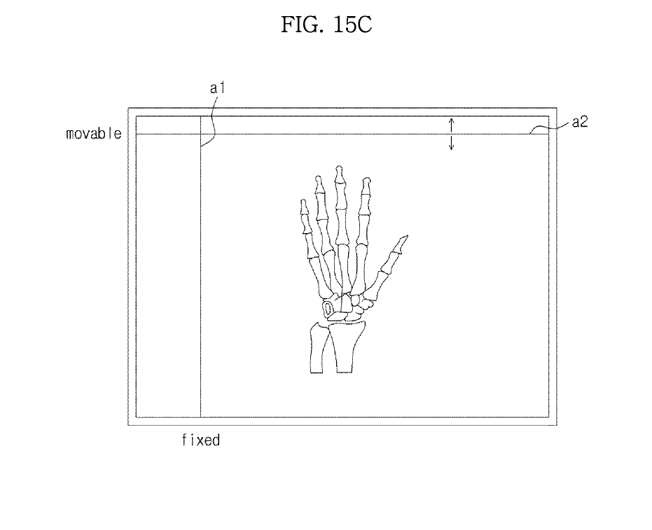

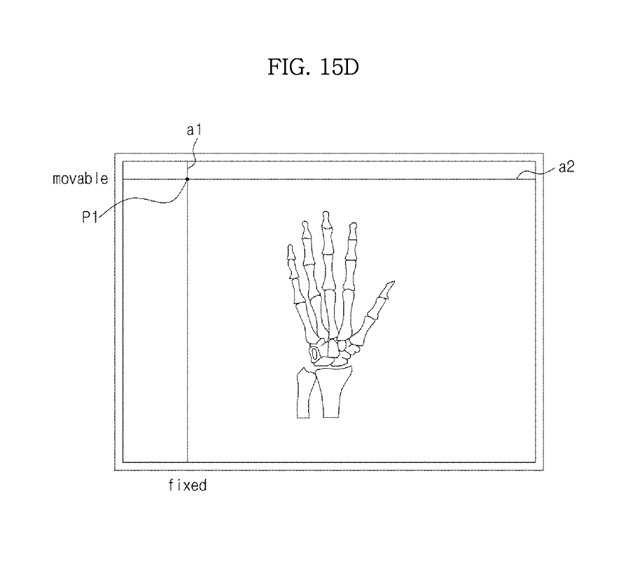

FIGS. 15A to 15D are views explaining a procedure of designating a selected-area of an X-ray image according to another embodiment of the present invention.

In an embodiment of the present invention, a screen for display of an X-ray image, as illustrated in FIGS. 15A to 15D, may display a vertical straight line a1 and/or a horizontal straight line a2 as well as an X-ray image.

The vertical straight line a1 and the horizontal straight line a2 may be moved in a desired direction according to a user action using the input unit 400, such as, for example, by moving a mouse or pushing a directional button of a keyboard. For example, the vertical straight line a1 may be moved in a left-and-right direction, and the horizontal straight line a2 may be moved in an up-and-down direction.

According to an embodiment of the present invention, to select a first position P1 for setting of a selected-area, first, after the user moves the vertical straight line a1 by operating the mouse or keyboard as illustrated in FIG. 15A, the user fixes the vertical straight line a1 at a desired position by clicking the mouse or the button of the keyboard as illustrated in FIG. 15B.

Once the vertical straight line a1 has been fixed, subsequently, the horizontal straight line a2 is displayed over the X-ray image. The user moves the horizontal straight line a2 as illustrated in FIG. 15C, and thereafter fixes the horizontal straight line a2 at a desired position (FIG. 15D).

In this case, according to an embodiment of the present invention, a point where the vertical straight line a1 and the horizontal straight line a2 intersect each other may be set to the first position P1. One of ordinary skill in the art would understand that the horizontal straight line a2 may alternatively be fixed first, and then the vertical straight line a1 may be fixed.

Once the first position P1 has been set, the selected-area X1 may be set by setting a second position P2 in the same manner as the above description. Alternatively, the selected area X1 may be generated or set after only the first position P1 is set, by using the center of the X-ray image as a reference point or origin, similar to operation S656 discussed above.

As described above, once the selected-area X1 has been set according to a user action, the controller 240, as illustrated in FIG. 11, may set an X-ray irradiation area based on information on the selected-area X1, for example, coordinate values of each angular point of a rectangle (if the selected-area X1 has a rectangular shape), or a distance I3 between the center position of the X-ray image and the first position P1, in other words, the size of the selected-area and the center position C (S660).

The X-ray irradiation area, according to an embodiment of the present invention, may be greater than the selected-area X1 as illustrated in FIG. 7.

Once the X-ray irradiation area has been set, the set irradiation area is stored in the storage unit 250. Then, when the user attempts to capture an image of the same object ob, for example, hands of a person, X-ray imaging may be performed by retrieving the stored irradiation area.

In this case, the controller 240 may control the collimator 120′ of the X-ray irradiator 100 by referring to the set X-ray irradiation area, so as to enable irradiation of X-rays to the set irradiation area. Therefore, an irradiation area may be reduced to a localized or desired are rather than emitting X-rays to a larger area, thereby reducing exposure to the object.

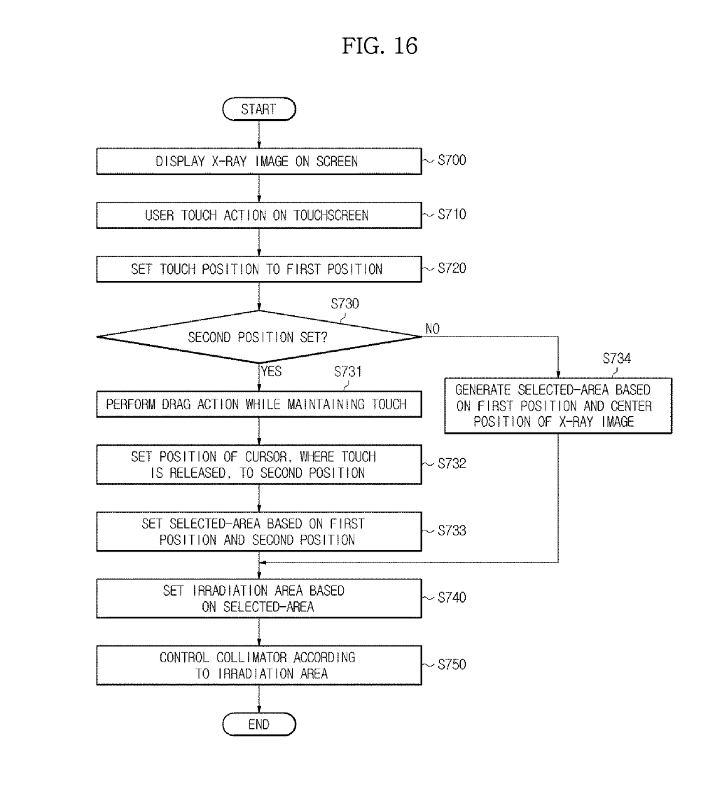

FIG. 16 is a flowchart illustrating an X-ray imaging area setting method using a touchscreen according to another embodiment of the present invention.

According to an embodiment of the present invention, the X-ray imaging area setting method, as illustrated in FIG. 8, may be performed by the X-ray imaging apparatus having the display unit 310 including a touchscreen.

As illustrated in FIG. 8, according to the embodiment of the X-ray imaging area setting method that is performed by the X-ray imaging apparatus having the display unit 310 including a touchscreen, first, an X-ray image acquired by the X-ray imaging apparatus is displayed on the touchscreen (S700).

Subsequently, if the user touches a desired position over the touchscreen on which an X-ray image is displayed (S710), the touch position is set to a first position P1 (S720).

According to an embodiment of the present invention, as described above, the selected-area may be acquired using coordinate values of the first position P1, or using the center position C of the X-ray image and the first position P1. More specifically, in one example, the rectangular selected-area X1 may be acquired using a distance between the center position C of the X-ray image and the first position P1 (for example, a straight-line distance between the center position C and P1, a distance in a horizontal direction between the center position C and P1, a distance in a vertical direction between the center position C and P1, and/or a distance in a diagonal direction between the center position C of the X-ray image and P1). Further, an angular distance between the center position C of the X-ray image and the first position P1 may be determined based on a reference line passing through the center position C, and a line passing through the center position C and P1.

According to another embodiment of the present invention, the user may also set a second position P2, in addition to the first position P1 (S730).

In this case, according to an embodiment of the present invention, the user may set the second position P2 by touching another position on the X-ray image rather than the first position P1.

According to another embodiment of the present invention, in a state in which the user continuously touches the first position P1, the user may perform a drag action as illustrated in FIG. 14B (S731). Thereafter, a position where the drag action is finished, i.e. a touch-release position may be set to the second position P2.

Subsequently, once the first position P1 and the second position P2 have been set, the controller 240 may set the selected-area X1 using the first position P1 and the second position P2.

In one example, the controller 240, as illustrated in FIG. 14C, may generate a rectangular selected-area X1, angular points of which face each other and correspond to the first position P1 and the second position P2.

Once the selected-area X1 has been set through the user touch action on the touchscreen, the controller 240, as illustrated in FIG. 16, may set an X-ray irradiation area based on information on the selected-area X1, and may store information on the X-ray irradiation area (S740).

The X-ray irradiation area, according to an embodiment of the present invention, may be greater than the selected-area X1 as illustrated in FIG. 7.

Once the X-ray irradiation area has been set, the set irradiation area is stored in the storage unit 250. Then, when the user attempts to capture an image of the same object ob (or same type of object), for example, hands of a person, X-ray imaging may be performed by retrieving the stored irradiation area.

In this case, the controller 240 may control the collimator 120′ of the X-ray irradiator 100 by referring to the set X-ray irradiation area, so as to enable irradiation of X-rays to the set irradiation area (S750).

Although not illustrated in the drawings, according to an embodiment of the present invention, the imaging area setting method of the X-ray imaging apparatus, as illustrated in FIG. 6, may include setting a selected-area using an X-ray irradiation area setter which includes the boundary line f to divide the selected-area X1 of the X-ray image from the other area X0, or a layer of various shapes overlapping the selected-area X1 to distinguish the selected-area X1 from the other area X0.

Specifically, if a display instruction of the X-ray irradiation area setter is input to the X-ray image displayed on the screen from the user, the X-ray irradiation area setter in the form of a frame defined by the boundary line f, for example, a rectangular frame is displayed, similar to the illustration of FIG. 6.

The X-ray irradiation area setter includes adjustment points, for example, angular points where a plurality of boundary lines f meet each other to adjust the size of the X-ray irradiation area setter or to move the X-ray irradiation area setter. Thus, the user may change an area of the X-ray image defined by the X-ray irradiation area setter by operating the X-ray irradiation area setter.

According to an embodiment of the present invention, if the X-ray irradiation area setter in the form of the rectangular frame is changed, the controller 240 generates a control instruction to control the X-ray irradiator 100, in particular, the collimator 120′, to irradiate X-rays to the changed area.

As is apparent from the above description, with an X-ray imaging apparatus and an imaging area setting method of an X-ray imaging apparatus according to the embodiments of the present invention as described above, it may be possible for the user, for example, a radiologist to easily and accurately set an X-ray imaging area.

Thus, the user may appropriately set a required imaging area for X-ray imaging.

Further, X-ray irradiation may be focused on a particular region of an object to be x-rayed, which may reduce unnecessary exposure of the object to radiation. This may cause the object to be exposed to less radiation and reduce or minimize the effect of radiation exposure on the object, more particularly, a human body.

Furthermore, by setting an X-ray imaging area based on an image rather than based on text, intuitive setting of an imaging area may be realized without depending on sense and experience of the user. This results in easier acquisition of a required range of an X-ray image.

Finally, in various types of image diagnosis using the imaging area setting method and the X-ray imaging apparatus, enhanced efficiency and accuracy may be accomplished.

Here it is noted that the X-ray imaging apparatus and control method according to the example embodiments disclosed herein may reduce unnecessary exposure of an object to radiation by enabling a user to select a specific area to be irradiated based on user inputs. Based on the area selected by the user, a controller may cause an X-ray irradiation control device to guide X-ray irradiation in a particular direction and/or within a particular range. The X-ray imaging apparatus and control method thereof according to the above-disclosed example embodiments may be applied to a target object including a human, an animal, or to any other objects for which a X-ray imaging may be applied (e.g., security applications such as airport security or border security, industrial applications such as taking x-ray images of welds, art applications such as taking x-ray images of paintings, etc.).

The X-ray imaging apparatus and methods according to the above-described example embodiments may use one or more processors, which may include a microprocessor, central processing unit (CPU), digital signal processor (DSP), or application-specific integrated circuit (ASIC), as well as portions or combinations of these and other processing devices.

Each block of the flowchart illustrations may represent a unit, module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

The method for controlling an X-ray imaging apparatus according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules that are recorded, stored, or fixed in one or more computer-readable storage media, in order to perform the operations of the above-described embodiments, or vice versa. The program instructions may be executed by one or more processors. In addition, a non-transitory computer-readable storage medium may be distributed among computer systems connected through a network and computer-readable codes or program instructions may be stored and executed in a decentralized manner. In addition, the computer-readable storage media may also be embodied in at least one application specific integrated circuit (ASIC) or Field Programmable Gate Array (FPGA).

Although the embodiments of the present invention have been shown and described, it would be appreciated by those skilled in the art that changes may be made to these embodiments without departing from the principles and spirit of the invention, the scope of which is defined in the claims and their equivalents.

What is claimed is:

1. An imaging area setting method of an X-ray imaging apparatus, the method comprising:
displaying, on a screen, an X-ray image with respect to an X-ray irradiation area acquired via X-ray irradiation of an X-ray irradiator;
receiving a selected-area generation instruction to select a partial area of the X-ray image displayed on the screen from a user; and
setting an updated X-ray irradiation area based on the selected partial area, and adjusting the X-ray irradiator to irradiate the updated X-ray irradiation area with X-rays.

2. The method according to claim 1, wherein adjustment of the X-ray irradiator includes controlling a collimator of the X-ray irradiator to adjust the X-ray irradiator.

3. The method according to claim 1, wherein the updated X-ray irradiation area coincides with the selected partial area, or is an area containing the entire selected partial area therein.

4. The method according to claim 1, wherein the selected-area generation instruction includes a selection instruction to designate at least one selection point on the X-ray image.

5. The method according to claim 1, wherein the selected partial area is generated based on a center position of the X-ray image, and a distance between the center position of the X-ray image and the selected at least one selection point.

6. The method according to claim 1, wherein the selected-area generation instruction includes a selection instruction to designate plural selection points on the X-ray image, and
wherein the selected partial area is generated based on the selected plural selection points.

7. The method according to claim 1, wherein the selected-area generation instruction is input by the user via an electric signal generated as the user moves a position marker displayed on the screen, or an electric signal generated as the user touches a touchscreen of a display unit connected to the X-ray imaging apparatus.

8. The method according to claim 1, wherein the selected partial area is displayed on the screen using a boundary line when the selected partial area is designated on the screen by the user.

9. The method according to claim 1, the method further comprising:
displaying, on a screen, a position marker that is moved on the screen according to a user's instruction.

10. An imaging area setting method of an X-ray imaging apparatus, the method comprising:
displaying, on a screen, an X-ray image acquired via X-ray irradiation of an X-ray irradiator, including a collimator, to an object;
displaying, on the screen, an X-ray irradiation area setter that divides a first area of the X-ray image from a second area, if a user inputs a display instruction of the X-ray irradiation area setter; and
if the first area of the X-ray image divided by the X-ray irradiation area setter is changed as the user operates the X-ray irradiation area setter, adjusting the X-ray irradiator so as to irradiate a changed area with X-rays,
wherein the X-ray irradiation area setter includes at least one of plural boundary lines that divide the first area from the second area, or a layer that overlaps the first area to divide the first area from the second area, and
wherein the X-ray irradiation area setter includes an adjustment point to adjust the size of the X-ray irradiation area setter or to move the X-ray irradiation area setter.

11. The method according to claim 10, wherein adjustment of the X-ray irradiator includes controlling the collimator of the X-ray irradiator to adjust the X-ray irradiator.

12. An imaging area setting method of an X-ray imaging apparatus, the method comprising:
displaying, on a screen, an X-ray image acquired by irradiating an X-ray irradiation area with X-rays;
entering a selected-area generation mode to select a partial area of the X-ray image displayed on the screen;
setting a selected-area based on a point or area designated on the screen by a user, and displaying the selected-area using a boundary line; and
changing the X-ray irradiation area based on the selected-area, and adjusting an X-ray irradiator so as to irradiate the changed X-ray irradiation area with X-rays.

13. An X-ray imaging apparatus comprising:
an X-ray irradiator to irradiate an object with the X-rays;
a detector to receive the X-rays having passed through the object and to change the X-rays into an electric signal;
a display unit to display an X-ray image based on the electric signal; and
a controller to process a selected-area generation instruction selecting a partial area of the displayed X-ray image, to control the display unit to display the selected partial area using a boundary line, to determine an updated X-ray irradiation area based on the selected partial area, and to control the X-ray irradiator to irradiate the updated X-ray irradiation area with X-rays.

14. The apparatus according to claim 13, wherein the controller controls a collimator of the X-ray irradiator to adjust the X-ray irradiator.

15. The apparatus according to claim 13, wherein the updated X-ray irradiation area coincides with the selected partial area, or is an area containing the entire selected partial area therein.

16. The apparatus according to claim 13, wherein the selected-area generation instruction includes a selection instruction to designate at least one selection point on the X-ray image.

17. The apparatus according to claim 13, wherein the selected-area generation instruction includes a selection instruction to designate plural selection points on the X-ray image, and
wherein the controller determines the selected partial area based on the selected plural selection points.

18. The apparatus according to claim 13, wherein the controller receives a user instruction via an electric signal generated as the user moves a position marker displayed on the display unit, or an electric signal generated as the user touches a touchscreen of the display unit.

19. The apparatus according to claim 13, further comprising an image processor to read out the X-ray image from the electric signal of the detector, and to perform predetermined image processing on the read out X-ray image for the display unit to display the X-ray image.

20. The apparatus according to claim 13, further comprising a storage unit to store information on the selected partial area or the updated X-ray irradiation area on a per object basis, according to a kind or size of the object.

21. An X-ray imaging apparatus comprising:
an X-ray irradiator to irradiate an object with X-rays and a collimator to guide the X-rays;
a detector to receive the X-rays having passed through the object and to change the X-rays into an electric signal;
a display unit including a touchscreen to display the X-ray image based on the electric signal and to receive an instruction according to a user touch action; and
a controller to receive a selection instruction to designate at least one selection point on the X-ray image according to the user touch action on the touchscreen, to set a selected-area based on the at least one selection point, to control the display unit to display the selected-area using a boundary line, to determine an updated X-ray irradiation area based on the selected-area, to adjust the X-ray irradiator to irradiate the updated X-ray irradiation area with X-rays.

22. The apparatus according to claim 21, wherein the controller controls an collimator of the X-ray irradiator to adjust the X-ray irradiator.

23. The apparatus according to claim 21, wherein the X-ray irradiation area coincides with the selected-area, or is an area containing the entire selected-area therein.

24. The apparatus according to claim 21, wherein the updated X-ray irradiation area is determined by increasing a size of the selected-area by adding a predetermined margin value to a distance between a center of the X-ray image and at least one point of the selected-area.
